(19) United States
(12) Patent Application Publication
(10) Pub. No.: US 2025/0243349 A1
(43) Pub. Date: Jul. 31, 2025

(54) POLYMER AND ITS PRODUCTION METHOD

(71) Applicant: National Tsing Hua University, Hsinchu City (TW)

(72) Inventors: Ann-Shyn Chiang, Hsinchu City (TW); Chih-Kuang Wang, Kaohsiung City (TW); Bo-Heng Liu, Hsinchu City (TW); Ko-Chen Hsu, Kaohsiung City (TW); Wei-Kun Chang, Hsinchu City (TW); Kai-Xiang Zhuang, Kaohsiung City (TW); Hui-Jen Lin, Hsinchu City (TW); Ming-Chin Wu, Hsinchu City (TW)

(73) Assignee: National Tsing Hua University, Hsinchu City (TW)

(21) Appl. No.: 19/034,452

(22) Filed: Jan. 22, 2025

Related U.S. Application Data
(60) Provisional application No. 63/627,048, filed on Jan. 30, 2024.

(51) Int. Cl. C08L 5/08; G01N 1/30

(52) U.S. Cl. CPC C08L 5/08; G01N 1/30; C08L 2201/54; G01N 2001/302

(57) ABSTRACT

A polymer and its production method provided by the disclosure use HAMA to modify the hydrogel. The modified hydrogel has properties of being insusceptible to breaking and has moderate strength for cutting and scanning. The modified hydrogel combined with iExM's technology may achieve a magnification of 60 times or more. In this way, the modified and expanded hydrogel sample may be cut for performing a layer-by-layer microscopic observation, so that the application of expansion microscopy is no longer limited by samples that are too large to be operated within the limited working distance, the application scope of expansion microscopy may be improved, and the novel iExM modified hydrogel system may be further applied to biological tissues to achieve a resolution scale of nearly tens of nanometers, so as to gain insight into the microstructure and mysteries of biological tissues and a deeper understanding of the structure and physiology of organisms.

### CROSS-REFERENCE TO RELATED APPLICATION

This application claims the priority benefit of U.S. provisional application Ser. No. 63/627,048, filed on Jan. 30, 2024. The entirety of the above-mentioned patent application is hereby incorporated by reference herein and made a part of this specification.

### BACKGROUND

### Technical Field

The disclosure relates to a polymer and a production method of the polymer, and particularly relates to a polymer and its production method.

### Description of Related Art

Expansion microscopy (ExM) is a super-resolution imaging technology. Such a method fixes fluorescent molecules on colloids, and then uses the water-absorbing and swelling characteristics of the hydrogel to expand the distance between the fluorescent molecules of the sample, thereby breaking through the diffraction limit and achieving the effect of improving resolution.

However, due to the limitation of the working distance of the fluorescence microscope, hydrogel samples beyond the working distance of the fluorescence microscope may not be observed, such that the application of ExM in large tissues and iterative expansion microscopy (iExM) is further limited. Most of the hydrogels currently on the market for ExM lack rigidity and are prone to fragmentation or are too elastic, making them difficult to cut. Therefore, how to develop hydrogel materials suitable for cutting and scanning using expansion microscopy is an important issue.

### SUMMARY

In view of this, the disclosure provides a polymer and its production method as a hydrogel to prepare samples for use in fluorescence microscopy at small working distances.

The disclosure provides a polymer production method, which includes: performing an immunostaining on a first sample to obtain a second sample; treating the second sample with an anchoring agent to obtain a third sample; placing the third sample in a first swelling hydrogel solution for infiltration to obtain a first polymer of a first embedded biological sample; placing the first polymer in an embedding polymer solution to obtain a second polymer of a second embedded biological sample; and placing the second polymer in a second swelling hydrogel solution to obtain a third polymer of a third embedded biological sample, where the second swelling hydrogel solution contains hyaluronic acid methacryloyl (HAMA).

In an embodiment of the disclosure, the step of placing the third sample in the first swelling hydrogel solution for infiltration to obtain the first polymer of the first embedded biological sample further includes: placing the first polymer in the first swelling hydrogel solution at least twice to swell the first polymer.

In an embodiment of the disclosure, the step of placing the third sample in the first swelling hydrogel solution for infiltration to obtain the first polymer of the first embedded biological sample further includes: placing the first polymer in a digestion buffer, where the digestion buffer includes Proteinase K or SDS.

In an embodiment of the disclosure, the first sample is a biological sample, and the first sample includes a cell, an organ, or a tissue.

In an embodiment of the disclosure, the immunostaining includes an immunofluorescence staining.

In an embodiment of the disclosure, the anchoring agent includes a reagent having a biomolecule-reactive chemical group and a hydrogel-reactive chemical group.

In an embodiment of the disclosure, the anchoring agent includes 6-((acryloyl)amino)hexanoic acid succinimidyl ester (Acryloyl-X), N-hydroxysuccinimide methacrylate (MA-NHS), or methacrolein.

In an embodiment of the disclosure, the first swelling hydrogel solution includes any one or combination of N,N-dimethylacrylamide (DMAA), acrylamide (AA), sodium acrylate (SA), N,N′-(1,2-dihydroxyethylene)bisacrylamide (DHEBA), and hyaluronic acid methacryloyl (HAMA).

In an embodiment of the disclosure, the embedding polymer solution includes any one or combination of acrylamide (AA), sodium acrylate (SA), and N,N′-(1,2-dihydroxyethylene)bisacrylamide (DHEBA).

In an embodiment of the disclosure, wherein the first swelling hydrogel solution and the embedding polymer solution further include a polymerization activator, where the polymerization activator includes ammonium persulfate (APS), potassium persulfate (KPS), or tetramethylethylenediamine (TEMED).

In an embodiment of the disclosure, the second swelling hydrogel solution includes any one or combination of N,N-dimethylacrylamide (DMAA), sodium acrylate (SA), hyaluronic acid methacryloyl (HAMA), and N,N′-methylenebisacrylamide (MBAA).

In an embodiment of the disclosure, a composition of the second swelling hydrogel solution includes: 10% to 40% N,N-dimethylacrylamide (DMAA), 10% to 30% sodium acrylate (SA), 0.01% to 2.0% hyaluronic acid methacryloyl (HAMA), and 0.001% to 0.5% N,N′-methylenebisacrylamide (MBAA).

In an embodiment of the disclosure, a molecular weight of hyaluronic acid methacryloyl is 0.1 kDa to 2000 kDa.

In an embodiment of the disclosure, a molecular weight of hyaluronic acid methacryloyl is 50 kDa to 80 kDa.

In an embodiment of the disclosure, the third polymer is used for microscopic analysis.

In an embodiment of the disclosure, before the step of performing immunostaining on the first sample to obtain the second sample, the step further includes: fixing the first sample with a fixative, where the fixative contains paraformaldehyde (PFA).

The disclosure also provides a polymer used for an embedded biological sample, which may be produced by the aforementioned production method.

In an embodiment of the disclosure, the embedded biological sample is used for microscopic analysis.

In an embodiment of the disclosure, the microscopic analysis includes application of expansion microscopy.

Based on the above, the disclosure uses HAMA to modify the hydrogel through a polymer production method. The modified hydrogel has properties of being insusceptible to breaking, and has moderate strength for cutting and scanning. The modified hydrogel combined with iExM's technology may achieve a magnification of 60 times or more. In this way, the modified hydrogel may make the application of expansion microscopy no longer be limited by the working distance, improve the application scope of expansion microscopy, and further advance the development of large tissues and iExM, so as to gain insight into the microstructure and mysteries of biological tissues and a deeper understanding of the structure and physiology of organisms.

### BRIEF DESCRIPTION OF THE DRAWINGS

FIG. 1 is a flow chart of a polymer production method of the disclosure.

FIG. 2 is a schematic diagram of the means for solving the problem in the disclosure.

FIG. 3 is a schematic diagram of a composition of a polymer of the disclosure.

FIG. 4 is a diagram of a polymer of the disclosure applied to a biological sample and observed under a microscope.

FIG. 5 is a schematic diagram of scanning and imaging of a biological sample after cutting with an ultrasonic knife according to the disclosure.

### DESCRIPTION OF THE EMBODIMENTS

Reference will now be made in detail to the present preferred embodiments of the disclosure, examples of which are illustrated in the accompanying drawings. The terms “first” and “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of elements. Also, where possible, elements/components using the same reference numerals in the drawings and embodiments represent the same or similar parts.

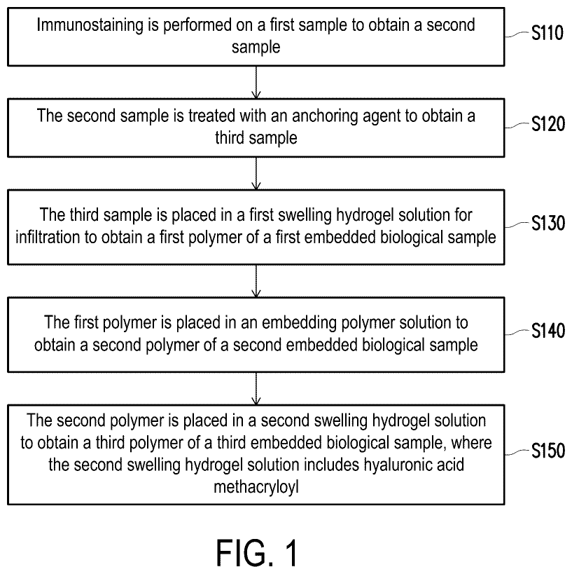

Referring to FIG. 1, FIG. 1 is a flow chart of a polymer production method of the disclosure. In flow S110, immunostaining is performed on a first sample to obtain a second sample. In flow S120, the second sample is treated with an anchoring agent to obtain a third sample. In flow S130, the third sample is placed in a first swelling hydrogel solution for infiltration to obtain a first polymer of a first embedded biological sample. In flow S140, the first polymer is placed in an embedding polymer solution to obtain a second polymer of a second embedded biological sample. In flow S150, the second polymer is placed in a second swelling hydrogel solution to obtain a third polymer of a third embedded biological sample, where the second swelling hydrogel solution includes hyaluronic acid methacryloyl.

In detail, the hydrogel polymer obtained by the disclosure has the properties of being insusceptible to breaking and moderately elastic, so that biological samples produced using the hydrogel polymer of the disclosure are easy to cut and not easy to break during cutting. This allows the hydrogel size to be kept within the working distance of a fluorescence microscope for fluorescence scanning of the biological samples.

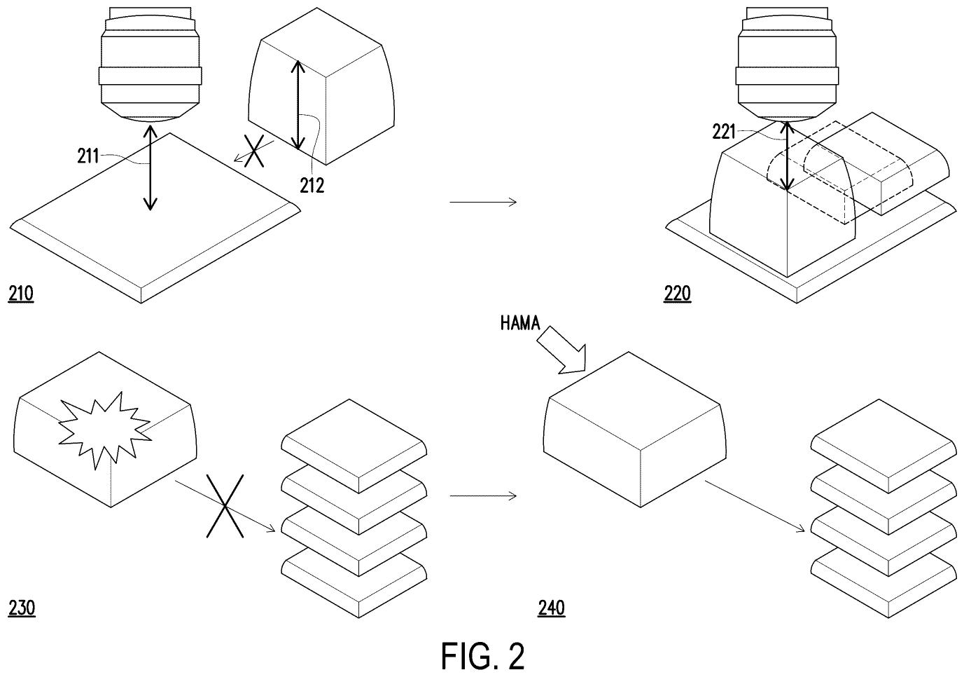

FIG. 2 is a schematic diagram of the means for solving the problem in the disclosure. Referring to FIG. 2, in phenomenon 210, a working distance 211 of the microscope is smaller than a height 212 of the biological sample embedded in the hydrogel, resulting in the biological sample being unable to be placed under the microscope for observation. Therefore, if the cut sample is obtained by cutting the hydrogel-embedded biological sample, as shown in phenomenon 220, there will be a gap 221 from the bottom of the microscope lens to the top of the cut sample, and at this time, the cut sample may be observed through the microscope.

Following the previous paragraph, however, biological samples made of traditionally used hydrogels have the problem of being easily broken when cut. As shown in phenomenon 230, if the sample is easily broken, it may not be cut into a thickness suitable for microscopic observation. Therefore, in phenomenon 240, if the polymer monomer hyaluronic acid methacrylate (HAMA) is added to the hydrogel as a cross-linking agent through the disclosure, the hydrogel composition commonly used in expansion microscopy may be improved, and the biological sample will not be easily broken when cutting the biological sample, which is suitable for cutting and scanning in expansion microscopy.

In embodiments of the disclosure, the hydrogel polymer is first formulated. The prepared hydrogel polymer and biological sample are then embedded.

In embodiments of the disclosure, specifically, first, immunostaining is performed on the sample (first sample) to obtain the immunostained sample (second sample). Next, the immunostained sample is treated with the anchoring agent to obtain the anchored immunostained sample (third sample). Next, the third sample is put into the first swelling hydrogel solution for infiltration to obtain the first polymer, and the first polymer is put into the embedding polymer solution to obtain the second polymer. Finally, the second polymer is placed into the second swelling hydrogel solution including hyaluronic acid methacryloyl to obtain the third polymer. The third polymer is the final hydrogel product of the disclosure. The aforementioned samples are biological samples, including cells, organs, or tissues. The aforementioned immunostaining includes an immunofluorescence staining.

In an embodiment of the disclosure, before the step of performing immunostaining on the sample to obtain the immunostained sample, the step further includes fixing the first sample with a fixative, and the fixative contains paraformaldehyde (PFA).

Furthermore, in an embodiment of the disclosure, the process of obtaining the aforementioned first polymer further includes placing the first polymer in the first swelling hydrogel solution twice to obtain the first polymer. That is to say, the first polymer may be placed in the first swelling hydrogel solution for a period of time, the first swelling hydrogel solution may be updated, and then the first polymer that has been soaked in the first swelling hydrogel solution may be immersed into the updated first swelling hydrogel solution. Finally, the first polymer soaked twice in the first swelling hydrogel solution is obtained.

Following the previous paragraph, since the first swelling hydrogel solution includes any one or combination of N,N-dimethylacrylamide (DMAA), acrylamide (AA), sodium acrylate (SA), N,N′-(1,2-dihydroxyethylene)bisacrylamide (DHEBA), and hyaluronic acid methacryloyl (HAMA), if the first polymer is soaked only once, the aforementioned molecules are unable to fully substitute the functional groups of the first polymer. Therefore, through two or more soaking processes, the above molecules may be greatly connected to the functional groups of the first polymer.

In an embodiment of the disclosure, the embedding polymer solution includes any one or combination of acrylamide (AA), sodium acrylate (SA), and N,N′-(1,2-dihydroxyethylene)bisacrylamide (DHEBA).

In other embodiments of the disclosure, the aforementioned first swelling hydrogel solution may include a polymerization activator, and the embedding polymer solution may also include a polymerization activator. The polymerization activator includes ammonium persulfate (APS), potassium persulfate (KPS), or tetramethylethylenediamine (TEMED). Through the polymerization activator, the added DMAA, AA, SA, or DHEBA may be more easily attached to the functional groups of the first polymer.

In embodiments of the disclosure, the second swelling hydrogel solution includes any one or combination of N,N-dimethylacrylamide (DMAA), sodium acrylate (SA), hyaluronic acid methacryloyl (HAMA), and N,N′-methylenebisacrylamide (MBAA). The composition of the second swelling hydrogel solution may include 10% to 40% N,N-dimethylacrylamide (DMAA), 10% to 30% sodium acrylate (SA), 0.01% to 2.0% hyaluronic acid methacryloyl (HAMA), and 0.001% to 0.5% N,N′-methylenebisacrylamide (MBAA).

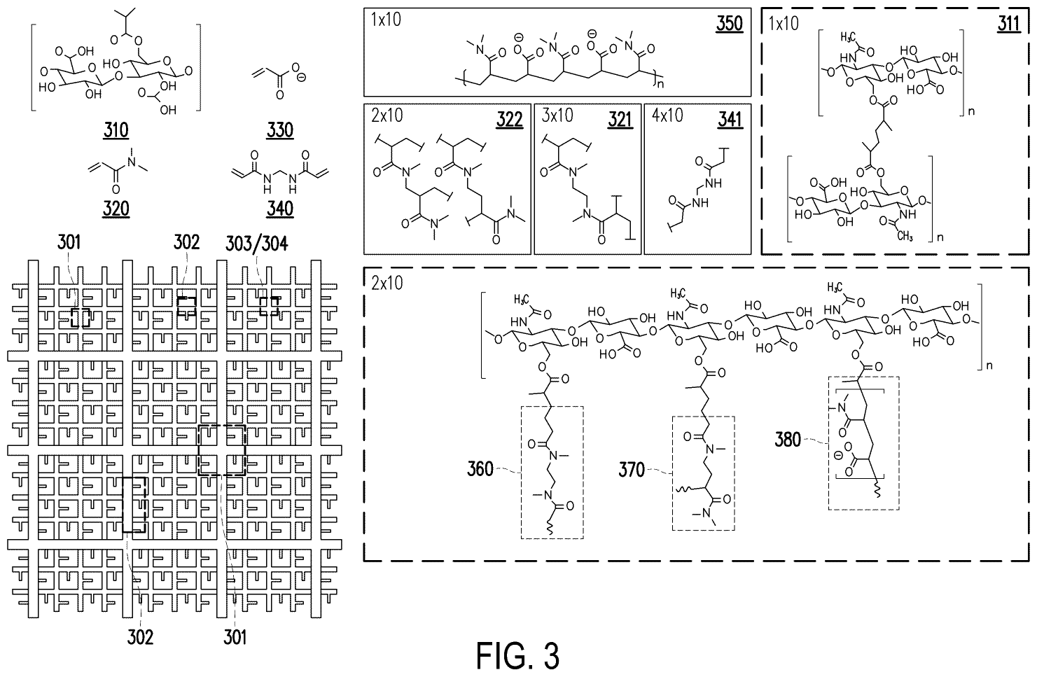

Referring to FIG. 3, FIG. 3 is a schematic diagram of a composition of a polymer of the disclosure. In the hydrogel, 301 is, for example, the polymer chain of AA/SA, 302 is, for example, the cross-linking of MBAA, 303 is the branch of DMAA, and 304 is, for example, the cross-linking of HAMA. The detailed molecular structure of HAMA is shown in molecule 310, the detailed molecular structure of DMAA is shown in molecule 320, the detailed molecular structure of SA is shown in molecule 330, and the detailed molecular structure of MBAA is shown in molecule 340.

Following the previous paragraph, the molecule 310 may form HAMA cross-linking through cross-linking. As shown in molecule 311, since HAMA may form cross-linking, the molecular weight of HAMA cross-linking may be determined by the number of cross-linking times. The molecular weight of different HAMA cross-linking may affect the final magnification, which will be detailed in subsequent paragraphs.

Following the previous paragraph, a molecule 350 is a polymer chain of DMAA/SA, which may be formed by cross-linking DMAA and SA. In addition, molecules 321 and 322 are the DMAA cross-link and the DMAA branch respectively, and molecule 341 is MBAA cross-links. As disclosed in the polymer production method, each of the aforementioned molecules may be added to the first swelling hydrogel solution, the embedding polymer solution, or the second swelling hydrogel solution respectively, so that the functional groups of the polymer may be replaced during the flow S130 to the flow S150, thereby achieving the magnification effect of the hydrogel polymer.

Continuing to refer to FIG. 3, molecule 360 is the HAMA/DMAA cross-link, molecule 370 is the HAMA/DMAA branch, and molecule 380 is the HAMA/DMAA/SA polymer chain. In the HAMA cross-linked polymer, molecules 360, 370, and 380 may replace the functional groups on the HAMA cross-linked polymer, thereby achieving the magnification effect of adding HAMA to the hydrogel polymer.

In another embodiment of the disclosure, the process of obtaining the aforementioned first polymer further includes placing the first polymer in a digestion buffer, and the digestion buffer may include Proteinase K or SDS.

In an embodiment of the disclosure, the anchoring agent includes a reagent having a biomolecule-reactive chemical group and a hydrogel-reactive chemical group. The anchoring agent may also include 6-((acryloyl)amino)hexanoic acid succinimidyl ester (Acryloyl-X), N-hydroxysuccinimide methacrylate (MA-NHS), or methacrolein. Through the anchoring agent, the functional groups on the obtained first polymer may be more stably attached to it.

In the embodiment of the disclosure, what is different from the content added to the polymer in the past is that hyaluronic acid methacryloyl is also added in the disclosure. Furthermore, the molecular weight of hyaluronic acid methacryloyl may also affect the subsequent magnification of the sample and the clarity of the sample. In an embodiment of the disclosure, the molecular weight of hyaluronic acid methacryloyl is 0.1 kDa to 2000 kDa. In other embodiments of the disclosure, the molecular weight of hyaluronic acid methacryloyl is 50 kDa to 80 kDa.

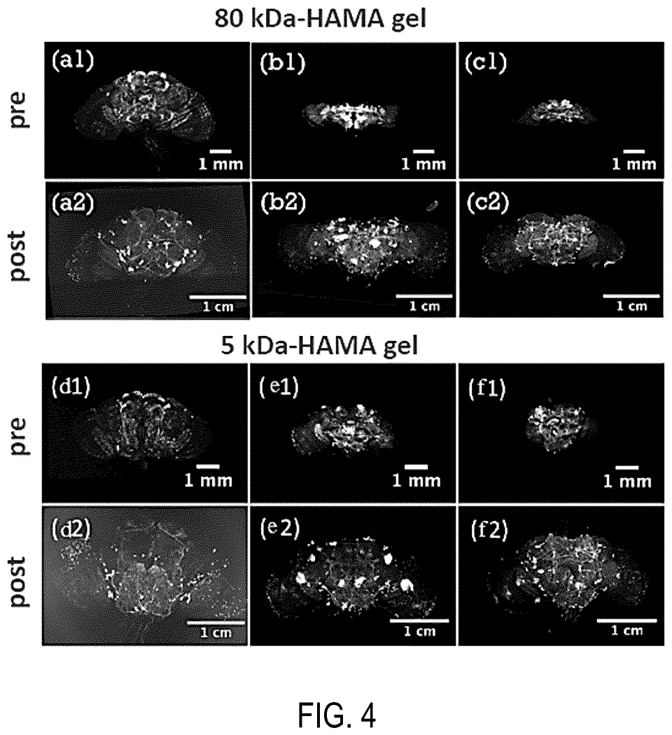

Referring to FIG. 4. FIG. 4 is a diagram of a polymer of the disclosure applied to a biological sample and observed under a microscope. As shown in FIG. 4, when hyaluronic acid methacryloyl (HAMA) is added to the hydrogel with a molecular weight of 80 kDa, it can be seen, from (a1), (b1), and (c1) observed under the microscope before adding and (a2), (b2), and (c2) observed after adding HAMA to the hydrogel for magnification, that in the 1 mm scale images of (a1), (b1), and (c1) and the 1 cm scale images of (a2), (b2), and (c2), the sizes of the tissues are almost the same. This means that if (a2), (b2), and (c2) are continuously enlarged to the 1 mm scale, a more detailed image of the internal tissue may be further observed. In the disclosure, adding HAMA with a molecular weight of 80 kDa to the hydrogel resulted in a magnification of 5.87 times. Therefore, the 10 times magnification of the microscope lens multiplied by the 5.87 times magnification of the hydrogel resulted in a magnification of 58.7 times.

Following the previous paragraph, if the molecular weight of hyaluronic acid methacryloyl (HAMA) added to the hydrogel is 5 kDa, it can be seen, from (d1), (e1), and (f1) observed under the microscope before adding and (d2), (e2), and (f2) observed after adding HAMA to the hydrogel for magnification, that in the 1 mm scale images of (d1), (e1), and (f1) and the 1 cm scale images of (d2), (e2), and (f2), the sizes of the tissues are almost the same. This means that if (d2), (e2), and (f2) are continuously enlarged to the 1 mm scale, a detailed image of the internal tissue may be further observed. In the disclosure, adding HAMA with a molecular weight of 5 kDa to the hydrogel resulted in a magnification of 6.18 times. Therefore, the 10 times magnification of the microscope lens multiplied by the 6.18 times magnification of the hydrogel resulted in a magnification of 61.8 times.

It can be seen from the above that after adding HAMA to the hydrogel, the original sample may be magnified approximately 6 times, and HAMA with different molecular weights may affect the final magnification. The implementer of the disclosure may adjust the molecular weight of HAMA according to actual requirements to obtain the desired magnification. And from the above, it may be further known that after adding HAMA, the expanded tissue is not damaged and is suitable for observation.

In embodiments of the disclosure, the third polymer obtained through the polymer production method may be used for embedding the biological sample, and further used for microscopic observation and subsequent analysis. In addition, the aforementioned microscopic analysis may further include application to expansion microscopy.

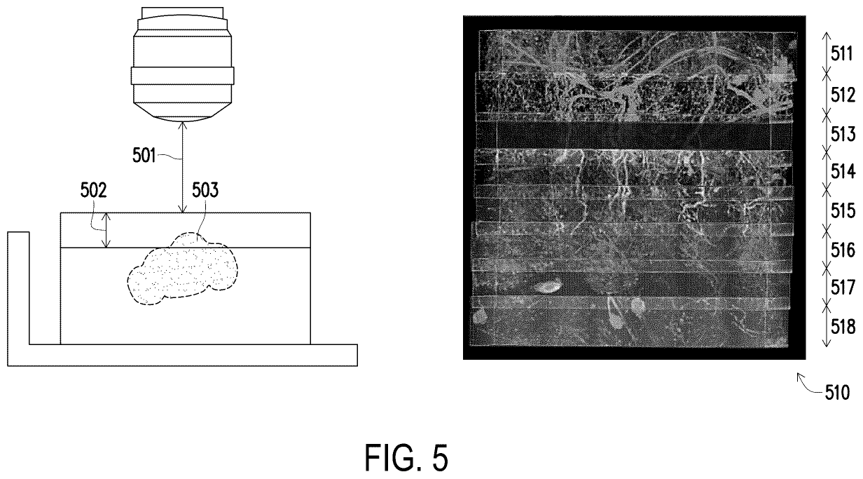

Referring to FIG. 5, FIG. 5 is a schematic diagram of scanning and imaging of a biological sample after cutting with an ultrasonic knife according to the disclosure. In FIG. 5, a 10 times magnification microscope lens was used, and the sample was magnified up to 6 times using a hydrogel polymer made as shown in FIG. 3. The total magnification is 60 times, which is the product of 10 times 6. Since the embedded sample is cut by the ultrasonic knife, the distance between the microscope lens and the sample may be 501. This distance may be, for example, 2500 μm, and a focusing distance 502 of each scan may be, for example, 1000 μm, and within this distance 502, the sample includes part of the tissue of an object under test 503. At this time, the observer may observe the state of the tissue of the object under test within the distance 502 through the microscope, and record the state as a fluorescent stained image within the distance 511 in a scanned tissue map 510, for example, by taking a photo. The observer may repeat the aforementioned behavior, and move the focus position a certain distance below the sample for each observation. In this way, the tissue of each layer of the sample of the object under test 503 corresponding to each observation may be recorded as distance 511 to distance 518.

Following the previous paragraph, since the hydrogel modified by the disclosure has the characteristics of making the sample easy to cut and not easy to break, the observer may also cut the embedded sample using an ultrasonic knife to have a layer height of 1000 μm, and conduct separate observations and recordings to compile a stack, as shown in the tissue map 510.

To sum up, the disclosure uses HAMA to modify the hydrogel through a polymer production method. The modified hydrogel has properties of being insusceptible to breaking, and has moderate strength for cutting and scanning. The modified hydrogel combined with iExM's technology may achieve a magnification of 60 times or more. In this way, the modified hydrogel may make the application of expansion microscopy no longer be limited by the working distance, improve the application scope of expansion microscopy, and further advance the development of large tissues and iExM, so as to gain insight into the microstructure and mysteries of biological tissues and a deeper understanding of the structure and physiology of organisms.

What is claimed is:

1. A polymer production method, comprising:
performing an immunostaining on a first sample to obtain a second sample;
treating the second sample with an anchoring agent to obtain a third sample;
placing the third sample in a first swelling hydrogel solution for infiltration to obtain a first polymer of a first embedded biological sample;
placing the first polymer in an embedding polymer solution to obtain a second polymer of a second embedded biological sample; and
placing the second polymer in a second swelling hydrogel solution to obtain a third polymer of a third embedded biological sample, wherein the second swelling hydrogel solution contains hyaluronic acid methacryloyl (HAMA).

2. The polymer production method according to claim 1, wherein placing the third sample in the first swelling hydrogel solution for infiltration to obtain the first polymer of the first embedded biological sample further comprises:
placing the first polymer in the first swelling hydrogel solution at least twice to swell the first polymer.

3. The polymer production method according to claim 1, wherein placing the third sample in the first swelling hydrogel solution for infiltration to obtain the first polymer of the first embedded biological sample further comprises:
placing the first polymer in a digestion buffer, wherein the digestion buffer comprises Proteinase K or SDS.

4. The polymer production method according to claim 1, wherein the first sample is a biological sample, and the first sample comprises a cell, an organ, or a tissue.

5. The polymer production method according to claim 1, wherein the immunostaining comprises an immunofluorescence staining.

6. The polymer production method according to claim 1, wherein the anchoring agent comprises a reagent having a biomolecule-reactive chemical group and a hydrogel-reactive chemical group.

7. The polymer production method according to claim 1, wherein the anchoring agent comprises 6-((acryloyl)amino)hexanoic acid succinimidyl ester (Acryloyl-X), N-hydroxysuccinimide methacrylate (MA-NHS), or methacrolein.

8. The polymer production method according to claim 1, wherein the first swelling hydrogel solution comprises any one or combination of N,N-dimethylacrylamide (DMAA), acrylamide (AA), sodium acrylate (SA), N,N′-(1,2-dihydroxyethylene)bisacrylamide (DHEBA), and hyaluronic acid methacryloyl (HAMA).

9. The polymer production method according to claim 1, wherein the embedding polymer solution comprises any one or combination of acrylamide (AA), sodium acrylate (SA), and N,N′-(1,2-dihydroxyethylene) bisacrylamide (DHEBA).

10. The polymer production method according to claim 1, wherein the first swelling hydrogel solution and the embedding polymer solution further comprise a polymerization activator, the polymerization activator comprises ammonium persulfate (APS), potassium persulfate (KPS), or tetramethylethylenediamine (TEMED).

11. The polymer production method according to claim 1, wherein the second swelling hydrogel solution comprises any one or combination of N,N-dimethylacrylamide (DMAA), sodium acrylate (SA), hyaluronic acid methacryloyl (HAMA), and N,N′-methylenebisacrylamide (MBAA).

12. The polymer production method according to claim 1, wherein a composition of the second swelling hydrogel solution comprises: 10% to 40% N,N-dimethylacrylamide (DMAA), 10% to 30% sodium acrylate (SA), 0.01% to 2.0% hyaluronic acid methacryloyl (HAMA), and 001% to 0.5% N,N′-methylenebisacrylamide (MBAA).

13. The polymer production method according to claim 1, wherein a molecular weight of the hyaluronic acid methacryloyl is 0.1 kDa to 2000 kDa.

14. The polymer production method according to claim 1, wherein a molecular weight of the hyaluronic acid methacryloyl is 50 kDa to 80 kDa.

15. The polymer production method according to claim 1, wherein the third polymer is used for microscopic analysis.

16. The polymer production method according to claim 1, wherein before the step of performing immunostaining on the first sample to obtain the second sample, the step further comprises:
fixing the first sample with a fixative, wherein the fixative contains paraformaldehyde (PFA).

17. A polymer used for an embedded biological sample, wherein the polymer is prepared by the method described in claim 1.

18. The polymer according to claim 17, wherein the embedded biological sample is used for microscopic analysis.

19. The polymer according to claim 18, wherein the microscopic analysis comprises an application of expansion microscopy.
